(19) United States
(12) Patent Application Publication
(10) Pub. No.: US 2026/0367591 A1
(43) Pub. Date: Nov. 19, 2026

(54) Methods And Apparatuses For Acquiring Optimal Control Parameters Of Pumps

(71) Applicant: Siemens Aktiengesellschaft, München (DE)

(72) Inventor: Cheng Feng, Peking, BJ (CN)

(73) Assignee: Siemens Aktiengesellschaft, München (DE)

(21) Appl. No.: 19/475,531

(22) PCT Filed: Apr. 18, 2023
(86) PCT No.: PCT/CN2023/088988

§ 371 Date: Oct. 15, 2025

(51) Int. Cl. G05B 13/04

(52) U.S. Cl. CPC G05B 13/042

(57) ABSTRACT

Various embodiments include a method for acquiring optimal control parameters of pumps. An example includes: establishing an optimization model with a constrained condition regarding a flow and a head of a plurality of pumps; generating control parameters of the plurality of pumps through the optimization model; calculating a total flow, a total head, and a total power of the plurality of pumps according to a simulation function of the pump and the control parameters; and if the total flow and the total head satisfy the constrained condition and the total power is minimum, transmitting the control parameters to a control for the pumps.

### CROSS-REFERENCE TO RELATED APPLICATIONS

This application is a U.S. National Stage Application of International Application No. PCT/CN2023/088988 filed Apr. 18, 2023, which designates the United States of America, the contents of which are hereby incorporated by reference in their entirety.

### TECHNICAL FIELD

The present disclosure relates to industrial control. Various embodiments of the teachings herein include methods and apparatus for acquiring optimal control parameters of pumps.

### BACKGROUND

The operating efficiency of a pump is closely related to its performance curve, usually provided by the manufacturer. In the operating phase, operating the pump at a high efficiency work point is the key to save energy. However, due to the wide variation in requirements for the pump, a single pump tends not to operate steadily close to its optimum efficiency point. Thus, in practice, a pump group consisting of several smaller pumps operating in parallel is often used to meet the requirements for the pump. However, when a plurality of non-identical pumps work in parallel, it may be harder to define a globally optimal solution which not only meets the pumping demand, but also achieves the minimum energy cost needs to be provided.

### SUMMARY

The summary of the present disclosure does not identify key features or essential features of the claimed subject matter, nor is it intended to be used as an aid in determining the scope of the claimed subject matter. The teachings of the present disclosure include a method for acquiring optimal control parameters of pumps, comprising: establishing an optimization model, with a constrained condition, regarding the flow and the head of a plurality of pumps (101); generating control parameters of the plurality of pumps through the optimization model, and calculating and obtaining the total flow, the total head and the total power of the plurality of pumps according to a simulation function of the pump and the control parameters (102); and if the total flow and the total head satisfy the constrained condition, and the total power is minimum, outputting the control parameters (103).

In some embodiments, the control parameters comprise respective on-off, respective speeds, and respective flows of the plurality of pumps, and generating control parameters of the plurality of pumps through the optimization model comprises: generating respective on-off, respective speeds and respective flows of the plurality of pumps through the optimization model.

In some embodiments, the numerical range of the respective speeds comprises 80% to 120% of respective rated speeds; the numerical range of the respective flows comprises zero to a maximum flow value; the states of the respective on-off comprise an on state and an off state, and initializing the respective on-off, the respective speeds and the respective flows of the plurality of pumps through the optimization model comprises: generating, by the optimization model, the numerical range of the respective speeds of the plurality of pumps, being 80% to 120% of the respective rated speeds, the numerical range of the respective flows, being zero to a maximum flow value, and the states of the respective on-off, being an on state or an off state.

In some embodiments, the simulation function of the pump comprises a head function and a power function of the pump regarding the flow at the rated speed, and calculating and obtaining the total flow, the total head and the total power of the plurality of pumps according to a simulation function of the pump and the control parameters comprises: calculating and obtaining the total flow, the total head and the total power of the plurality of pumps according to the head function and the power function of the pump regarding the flow at the rated speed and the control parameters.

As another example, some embodiments include an apparatus (200) for acquiring optimal control parameters of pumps, comprising: an optimization model establishing module (201), used for establishing an optimization model, with a constrained condition, regarding the flow and the head of a plurality of pumps; a simulation function calculating module (202), used for generating control parameters of the plurality of pumps through the optimization model, and calculating and obtaining the total flow, the total head and the total power of the plurality of pumps according to a simulation function of the pump and the control parameters; and a control parameter outputting module (203), used for, if the total flow and the total head satisfy the constrained condition, and the total power is minimum, outputting the control parameters.

In some embodiments, the control parameters comprise respective on-off, respective speeds, and respective flows of the plurality of pumps, and the simulation function calculating module (202) is further used for generating respective on-off, respective speeds and respective flows of the plurality of pumps through the optimization model.

In some embodiments, the numerical range of the respective speeds comprises 80% to 120% of respective rated speeds; the numerical range of the respective flows comprises zero to a maximum flow value; the states of the respective on-off comprise an on state and an off state, and the simulation function calculating module (202) is further used for generating, by the optimization model, the numerical range of the respective speeds of the plurality of pumps, being 80% to 120% of the respective rated speeds, the numerical range of the respective flows, being zero to a maximum flow value, and the states of the respective on-off, being an on state or an off state.

In some embodiments, the simulation function of the pump comprises a head function and a power function of the pump regarding the flow at the rated speed, and the simulation function calculating module (202) is further used for calculating and obtaining the total flow, the total head and the total power of the plurality of pumps according to the head function and the power function of the pump regarding the flow at the rated speed and the control parameters.

As another example, some embodiments include a computer device, comprising a memory and a processor, the memory storing a computer program, wherein the processor, when executing the computer program, implements one or more of the methods described herein.

As another example, some embodiments include a computer-readable storage medium, storing a computer program, wherein the computer program, when executed by a processor, implements one or more of the methods described herein.

As another example, some embodiments include a computer program product, stored on a tangible computer-readable medium and comprising computer-executable instructions, the computer-executable instructions, when executed, enabling at least one processor to perform one or more of the methods described herein.

### BRIEF DESCRIPTION OF THE DRAWINGS

In the accompanying drawings, implementations of the present disclosure are illustrated by way of examples, and not by way of limitation, and similar reference numerals in the accompanying drawings refer to same or similar components. In the drawings:

FIG. 1 is a schematic diagram of a method for acquiring optimal control parameters of pumps incorporating teachings of the present disclosure;

FIG. 2 is a schematic diagram of an apparatus for acquiring optimal control parameters of pumps incorporating teachings of the present disclosure; and

FIG. 3 is a schematic diagram of a computer device for acquiring optimal control parameters of pumps incorporating teachings of the present disclosure.

Reference numerals are as follows:
S101-S103 steps
200: apparatus
201: module
202: module
203: module
204: module
205: module
300: computer device
302: processor
304: memory

### DETAILED DESCRIPTION

Some embodiments of the teachings herein include a method for acquiring optimal control parameters of pumps, including: establishing a black-box optimization model, with a constrained condition, regarding the flow and the head of a plurality of pumps; generating control parameters of the plurality of pumps through the optimization model, and calculating and obtaining the total flow, the total head and the total power of the plurality of pumps according to a simulation function of the pump and the control parameters; and if the total flow and the total head satisfy the constrained condition, and the total power is minimum, outputting the control parameters. In this way, the optimal control parameters of the plurality of pumps can be obtained by calculating the minimum power values of the plurality of pumps at a certain head and flow, so as to save power and facilitate the control of the plurality of pumps.

Further, the control parameters include respective on-off, respective speeds, and respective flows of the plurality of pumps, and generating control parameters of the plurality of pumps through the optimization model includes generating respective on-off, respective speeds and respective flows of the plurality of pumps through the optimization model. By setting the above control parameters, it is possible to effectively obtain individual control parameters of each pump when a plurality of pumps work together, thereby achieving accurate control, and the total power of the plurality of pumps is the lowest at a certain head and flow.

In some embodiments, the method includes that: the numerical range of the respective speeds includes 80% to 120% of respective rated speeds; the numerical range of the respective flows includes zero to a maximum flow value; the respective on-off includes an on state and an off state, and initializing the respective on-off, the respective speeds and the respective flows of the plurality of pumps through the optimization model includes: generating, by the optimization model, the numerical range of the respective speeds of the plurality of pumps, being 80% to 120% of the respective rated speeds, the numerical range of the respective flows, being zero to a maximum flow value, and the states of the respective on-off, being an on state or an off state. In this way, the search space for the control parameter can be limited to an effective and reasonable range, so that the optimal control parameter can be found in the interval, and the minimum total power when the plurality of pumps work together can be obtained.

In some embodiments, the simulation function of the pump includes a head function and a power function of the pump regarding the flow at the rated speed, and calculating and obtaining the total flow, the total head and the total power of the plurality of pumps according to a simulation function of the pump and the control parameters includes: calculating and obtaining the total flow, the total head and the total power of the plurality of pumps according to the head function and the power function of the pump regarding the flow at the rated speed and the control parameters. In this way, the control parameters can be substituted into the simulation function, so as to obtain the functional relationship between the flow and the head and the functional relationship between the flow and the power of the pump at a certain rated power, so as to provide parameters of a subsequent constrained condition and calculate the minimum power value.

In some embodiments, the method further includes: initializing an evolution strategy of the optimization model; and updating the evolution strategy of the optimization model. In this way, the evolution strategy of the optimization model can be set and adjusted so as to find the control parameters of the plurality of pumps more quickly and accurately.

Some embodiments include an apparatus for acquiring optimal control parameters of pumps, including: an optimization model establishing module, used for establishing a black-box optimization model, with a constrained condition, regarding the flow and the head of a plurality of pumps; a simulation function calculating module, used for generating control parameters of the plurality of pumps through the optimization model, and calculating and obtaining the total flow, the total head and the total power of the plurality of pumps according to a simulation function of the pump and the control parameters; and a control parameter outputting module, used for, if the total flow and the total head satisfy the constrained condition, and the total power is minimum, outputting the control parameters.

In some embodiments, the control parameters include respective on-off, respective speeds, and respective flows of the plurality of pumps, and the simulation function calculating module (202) is further used for generating respective on-off, respective speeds and respective flows of the plurality of pumps through the optimization model.

In some embodiments, the numerical range of the respective speeds includes 80% to 120% of respective rated speeds; the numerical range of the respective flows includes zero to a maximum flow value; the respective on-off includes an on state and an off state, and the simulation function calculating module (202) is further used for generating, by the optimization model, the numerical range of the respective speeds of the plurality of pumps, being 80% to 120% of the respective rated speeds, the numerical range of the respective flows, being zero to a maximum flow value, and the states of the respective on-off, being an on state or an off state.

In some embodiments, the simulation function of the pump includes a head function and a power function of the pump regarding the flow at the rated speed, and the simulation function calculating module (202) is further used for calculating and obtaining the total flow, the total head and the total power of the plurality of pumps according to the head function and the power function of the pump regarding the flow at the rated speed and the control parameters.

In some embodiments, the method further includes: initializing an evolution strategy of the optimization model; and updating the evolution strategy of the optimization model.

Some embodiments include a computer device, including a memory and a processor, the memory storing a computer program, where the processor, when executing the computer program, implements one or more of the methods described herein.

Some embodiments include a computer-readable storage medium, storing a computer program that, when executed by a processor, implements one or more of the methods described herein.

Some embodiments include a computer program product, stored on a tangible computer-readable medium and including computer-executable instructions that, when executed, enabling at least one processor to perform one or more of the methods described herein.

In this disclosure, for purposes of explanation, numerous specific details are set forth. However, various embodiments of the teachings of the present disclosure may be implemented without all of the specific details. In other examples, known circuits, structures, and technologies are not disclosed in detail, so as not to obscure understanding on the description. Throughout the disclosure, references to “one implementation”, “implementation”, “exemplary implementation”, “some implementations”, “various implementations”, and so forth, mean that the described implementation can include specific features, structures, or characteristics, but do not mean that each implementation necessarily includes such specific features, structures, or characteristics. Moreover, some implementations may have some, all, or none of the features described for other implementations.

In the following disclosure, the terms “coupled” and “connected”, along with their derivatives, may be used. It is to be understood that these terms are not intended as synonyms for each other. Rather, “connected” is used to indicate that two or more components are in direct physical or electrical contact with each other, and “coupled” is used to indicate that two or more components co-operate or interact with each other, although they may or may not be in direct physical or electrical contact.

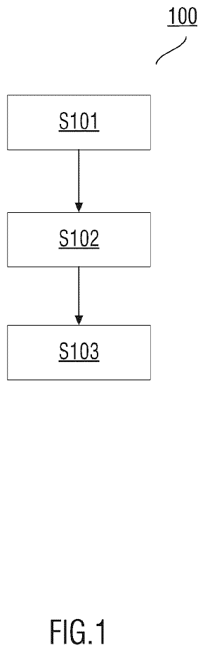

FIG. 1 is a flowchart illustrating a production method incorporating teachings of the present disclosure. At any moment, assuming that the total realistic pumping demand involves in a certain head and flow, the optimization objective, or problem to be solved, is to find the best control parameter of each pump, namely the on-off, the speed and the flow of each pump, so as to minimize the sum of the power of each pump, or the total energy consumption, under the premise of satisfying the above constrained condition of the total head and flow.

Based on this, an example method for acquiring optimal control parameters of pumps comprises:
S101: establishing an optimization model, with a constrained condition, regarding the flow and the head of a plurality of pumps. Specifically, for the optimization model, the Covariance Matrix Adaptation Evolution Strategy (CMA-ES) or constrained Bayesian optimization (CBO) can be selected as an optimization model, and these models can be, based on a constrained condition, subjected to iterations for many times so that the optimal solution, or the optimal optimization objective can be calculated. The optimization model may also be referred to as a black-box optimization model, denoting the definition of a black-box to the outside world, and by means of an input to the model, and calculation inside the model, a calculation result is then output to the outside world.

The method operates to calculate and obtain the optimization objective under the constrained condition. For example, the implementation scenario of the present application is that at any moment, assuming that the total pumping demand involves in a head H and a flow Q, the optimization objective is to find the best control parameter (u₁,r₁,Q₁, . . . , uₙ,rₙ,Qₙ), namely the on-off, the speed and the flow of each pump, so as to minimize the total energy consumption

$${\sum }_{i = 1}^{n} {W}_{i} ,$$

under the premise of satisfying the constrained condition of the head and the flow. The optimization objective, expressed in an equation, can be as follows, and the specific details and meaning of which will appear later in the description, with the meaning in the context to be consistent:

$${u}_{1}^{*} , {r}_{1}^{*} , {Q}_{1}^{*} , … , {u}_{n}^{*} , {r}_{n}^{*} , {Q}_{n}^{*} = arg min {\sum }_{i = 1}^{n} {W}_{i}$$

in addition, the constrained condition for the flow and the head of the pump is a function fitted and defined by the present application. As the flow and the head of the pump determine the water output of the pump, it is also indirectly related to the subsequent operating power of the pump (referred to as power). When a plurality of pumps work together, the individual flow, head or on-off situation of each pump needs to be adjusted under the requirements of a certain total flow and total head, so that the above constrained conditions for the flow and head of the pump can be expressed as:

$$s . t . \vert Q - {\sum }_{i = 1}^{n} {Q}_{i} \vert < tolQ and ∀ i ∈ \{ 1 , … , n \} : 0 \leq ( {H}_{i} - H ) {u}_{i} < tolH$$

where s.t. stands for strict to, meaning constrained; Q denotes the expected total flow, and Qᵢ denotes the flow of an individual pump. tolQ denotes the tolerance of the flow. In the above equation, the expression before and means that the absolute value of the difference between the total flow and the sum of the flows of all individual pumps needs to be less than the tolerance of the flow.

Correspondingly, Hᵢ denotes the head of the individual pump, H denotes the expected head for the individual pump, tolH denotes the tolerance of the head, and uᵢ denotes the on-off state of the individual pump (which can take the values 0 and 1; 0 for off, and 1 for on), in the above equation, the expression after and means that if the difference between the head of the individual pump and the expected head can be as small as 0 and as large as the tolerance of the head.

Further, to address the need to obtain the minimum power of the plurality of pumps at a certain head and flow, the optimization objective is expressed as follows:

$$arg min {\sum }_{i = 1}^{n} {W}_{i}$$

where argmin denotes the calculated minimum value, and Wᵢ denotes the power of the individual pump. Therefore, when the above constrained condition of s.t is satisfied, the optimization objective needs to be calculated so that the sum of the powers of the plurality of pumps is obtained as a minimum value. In this way, the corresponding optimization objective and constrained condition can be written into the optimization model, so that the optimization model can be used to carry out calculations to find the subsequent optimal solution required.
S102: Generating control parameters of the plurality of pumps through the optimization model, and calculating and obtaining the total flow, the total head and the total power of the plurality of pumps according to a simulation function of the pump and the control parameters. The optimization model, after obtaining the optimization objective and constrained condition, correspondingly generates control parameters of the plurality of pumps, where the control parameter of each pump can be expressed as (uᵢ,rᵢ,Qᵢ), where uᵢ denotes the on-off state of the individual pump, rᵢ denotes the speed of the individual pump, and Qᵢ denotes the flow of the individual pump. When the plurality of pumps work together, their control parameters can be expressed as ((u₁, r₁, Q₁, . . . , uₙ, rₙ, Qₙ)), where n denotes the specific number of the pumps.

In the above optimization objective, a functional relationship is established between the power and the control parameter, in other words, as a result of the above control parameter, it results in a corresponding power generated by the operation of the plurality of pumps for pumping water, so that for the problem mentioned earlier in the present application, it is necessary to find the optimal control parameters of the plurality of pumps, so that under a certain expected total flow and expected head, the power of the plurality of pumps is minimum, or most energy is saved, which is specifically expressed as follows:

$${u}_{1}^{*} , {r}_{1}^{*} , {Q}_{1}^{*} , … , {u}_{n}^{*} , {r}_{n}^{*} , {Q}_{n}^{*} = arg min {\sum }_{i = 1}^{n} {W}_{i}$$

Further, the range of values of the above control parameters, or the search range of the optimization model for each control parameter, is as follows: the on-off state of the individual pump can be 0 or 1, the speed of the individual pump can be in the range of 80% to 120% of the rated speed of each pump, and the flow of the individual pump can be from the minimum flow to the maximum flow. The minimum flow may be 0 and the maximum flow is the rated maximum flow of the pump.

In some embodiments, the simulation function of the pump includes a head function and a power function of the pump regarding the flow at the rated speed.

In some embodiments, the optimization model generates a set of control parameters within the above range of values of the control parameters, and by means of the control parameters, the corresponding head and power of the pump can be calculated. That is, after generating the control parameters, the head and power of the individual pump can be calculated based on the simulation function of the pump. Specifically, the simulation function can be calculated according to the law of proportionality as follows:

$${H}_{i} = {( \frac{{r}_{i}}{{R}_{i}} )}^{2} * {f}_{H} ( {Q}_{i} * \frac{{R}_{i}}{{r}_{i}} )$$

$${W}_{i} = {( \frac{{r}_{i}}{{R}_{i}} )}^{3} * {f}_{w} ( {Q}_{i} * \frac{{R}_{i}}{{r}_{i}} )$$

Where Rᵢ is the rated speed of the individual pump, in some cases, the rated speed of each pump can also be individually different, rᵢ is the speed of the individual pump in the control parameters, Qᵢ is the flow of the individual pump in the control parameters, and f_{H}denotes the relationship between the flow and head of the individual pump at a certain rated speed. f_{w} denotes the relationship between the flow and the power of the individual pump at a certain rated speed, and i indicates a pump in the plurality of pumps.

In some implementation modes, the pump has a reference manual or comes with its own a functional relationship or curve graph of the flow and the head, and a functional relationship or curve graph of the flow and the power. If the above reference manual or functional relationship or graph is not available, at rated speed, flow and pressure sensors can be installed and the above functional relationship or curve graph regarding the flow and head of the pump and the above functional relationship or curve graph of the flow and the power can be obtained.
S103: If the total flow and the total head satisfy the constrained condition, and the total power is minimum, outputting the control parameters. In this way, obtained Hᵢ, Qᵢ and Wᵢ are substituted into the above constrained conditions and optimization objective, and when the constrained condition of the head and the flow are satisfied, the total power at the moment, i.e. the sum of a plurality of Wᵢ is recorded. The optimization model may generate a plurality of control parameters to record corresponding total power values that satisfy the constrained condition. After iteration is performed for many times and the control parameter is generated, the control parameter with the smallest total power value can be output as a final optimized control parameter.

In some embodiments, the optimization model initializes and sets its evolution strategy and updates the evolution strategy of the optimization model in the process of generating the control parameters. The evolution strategy is mainly to quickly find the control parameter with the smallest total power value of the plurality of pumps within the numerical range of the control parameter defined above, or the search space of the control parameter. The optimization model can find optimal control parameters in the search space by numerical exploration, span adjustment and the like. If the range of values of the three control parameters is considered as a three-dimensional space as a whole, it means that the optimal control parameter is found most quickly in the three-dimensional space.

In some embodiments, the numerical range of the respective speeds includes 80% to 120% of respective rated speeds; the numerical range of the respective flows includes zero to a maximum flow value; the states of the respective on-off include an on state and an off state. The corresponding meaning can also be expressed as:

$${u}_{i} ∈ \{ 0 , 1 \} , {r}_{i} ∈ ( 0.8 {R}_{i} , 1.2 {R}_{i} ) , {Q}_{i} ∈ ( 0 , {Q}_{i}^{m ax} ) .$$

The present disclosure describes a general solution for the optimization of a variable speed pump (VSP) group, maximizing the total efficiency of the pump group while achieving the required pumping demand. In some literature, it has been shown that if the identical pumps are operated under the same conditions, then the identical pumps operating in parallel have the highest efficiency. Other literature also suggests solutions for finding an optimum number of working pumps for the identical pumps working in parallel. There is some literature in which the problem of optimizing the power of groups consisting of non-identical pumps has been studied. Previous work has aimed at searching for analytical solutions for fixed head and flow requirements. In the present disclosure, we provide a more general solution through the combination of simulation and black-box optimization, which can be applied to a wide range of practical scenarios with different pumping demands.

In summary, the Problem Statement can be formulated as follows: suppose that there are n variable speed pumps working in parallel, each having its own performance curve. We denote controllable parameters of the pump by (u, r, Q), where u∈{0,1} represents the on-off of the pump, r∈[r_min, r_max] represents the operating speed of the pump and Q∈[Q min, Q max] represents the flow of the pump.

Thus, at any moment, the total pumping demand is assumed to be the head H and the flow Q. The optimization objective is to find the best control parameter (u₁,r₁,Q₁, . . . , uₙ,rₙ,Qₙ) namely the on-off, speed and flow of each pump, so as to minimize the total energy consumption under the premise of satisfying the head and the flow requirements.

The procedure is as follows:
step 1 (optionally): determining the performance curve of the pump. Generally, the performance curve of the pump is provided by the manufacturer, so the step can be ignored. Otherwise, we need to install flow and pressure sensors to determine the performance curve of the pump. We need to determine the following performance curves at the rated speed of the pumps: A Q-H (flow and head) curve and a Q-W (flow and power) curve.
Step 2: establishing a simulation function for the pump group. Based on the Q-H and Q-W curves of the pump at the rated speed, a simulation model or simulation function is created by using the law of proportionality. The simulation function acts as a black-box to simulate the actual situation. Specifically, by inputting (u, r, Q) of a particular pump, the corresponding (H, W) of the pump will be output according to the simulation function. More specifically, R is enabled to denote the rated speed of the pump, f_{H}(Q) denotes the function for outputting the head of the pump under the flow Q at the rated rotating speed (derived directly from the Q-H curve), f_{w}(Q) denotes the function for outputting the power of the pump under the flow Q at the rated rotating speed (derived directly from the Q-W curve), and then (u, r, Q) of the pump are given, we use the law of proportionality to calculate the head and the power thereof as follows:

$$H = {( \frac{r}{R} )}^{2} * {f}_{H} ( Q * \frac{R}{r} )$$

$$W = {( \frac{r}{R} )}^{3} * {f}_{w} ( Q * \frac{R}{r} )$$

Finally, the simulation model is denoted as follows:

(H₁,W₁, . . . ,Hₙ,Wₙ)=sim(u₁,r₁,Q₁, . . . ,uₙ,rₙ,Qₙ)
where when the on-off, speed and flow of the pump are used as inputs, the resulting head and power of the pump are output.
Step 3: searching for optimal control parameters. To find the optimal control parameters of the pump, arbitrary pumping demands Q and H are given, we first formulate the optimization objective as follows:

$${u}_{1}^{*} , {r}_{1}^{*} , {Q}_{1}^{*} , … , {u}_{n}^{*} , {r}_{n}^{*} , {Q}_{n}^{*} = {arg min}_{{( {u}_{i} ∈ \{ 0 , 1 \} , {r}_{i} ∈ ( 0.8 {R}_{i} , 1.2 {R}_{i} ) , {Q}_{i} ∈ ( 0 , {Q}_{i}^{m ax} ) )}_{1}^{n}} {\sum }_{i = 1}^{n} {W}_{i}$$

$$s . t . \vert Q - {\sum }_{i = 1}^{n} {Q}_{i} \vert < tolQ and ∀ i ∈ \{ 1 , … , n \} : 0 \leq ( {H}_{i} - H ) {u}_{i} < tolH$$

where Hᵢ and Wᵢ respectively refer to the head and the power of the i^{th} pump in state (uᵢ,rᵢ,Qᵢ), and tolQ and tolH are the tolerance thresholds of the flow and the head requirements, respectively. Further, we set the speed search space of each pump as (0.8Rᵢ, 1.2Rᵢ), where Rᵢ is the rated speed of the i^{th} pump, because the law of proportionality is oftentimes inaccurate when the change in speed is greater than 20% of the rated speed.

In summary, the above is a constrained black-box optimization problem that can be solved by a black-box optimization algorithm, such as CMA-ES and constrained Bayesian optimization. Taking the CMA-ES algorithm as an example, we solve the constrained black-box optimization problem as follows.
1. According to the above constrained objective function (constrained objective function), the constrained fitness function of CMA-ES is initialized.
2. The evolution strategy of CMA-ES is initialized.
3. A set of candidate control parameters is proposed by using the CMA-ES algorithm.
4. For each candidate control parameter (u₁,r₁,Q₁, . . . , uₙ,rₙ,Qₙ), we use the simulation function (H₁,W₁, . . . , Hₙ,Wₙ)=sim (u₁,r₁,Q₁, . . . , uₙ,rₙ,Qₙ) to obtain the resulting head and power of each pump. Whether the candidate control parameter satisfies all the constrained conditions is checked, and if yes, the total power of the candidate control parameter is calculated and recorded.
5. The simulation result is used to update the fitness function of CMA-ES.
6. If the lowest total power does not change in several consecutive iterations, the candidate control parameter is returned with the lowest total power to date. Otherwise, operation goes to step 3 and new iteration is performed.

In summary, we have combined the simulation of the pump and the black-box optimization to automatically search for the best control parameters of the pump group, rather than manually defining an analytical solution, which requires a high technology domain and mathematical expertise. This results in two main benefits.
1. Our solution is prone to productization and once it is in productization, no domain or mathematical expertise is required to use our solution.
2. Our solution is more versatile as it can handle situations with different numbers of pumps and pump requirements.

It is to be understood that, although each step of the flowcharts in FIG. 1 is displayed sequentially according to arrows, the steps are not necessarily performed according to an order indicated by the arrows. Unless otherwise explicitly specified in the present application, execution of the steps is not strictly limited, and the steps may be performed in other orders. Moreover, at least part of the steps in FIG. 1 may include a plurality of steps or a plurality of stages. These steps or stages are not necessarily executed at the same time but can be executed at different times.

The order of execution of these steps or stages is not necessarily performed sequentially but may be performed in turn or alternately with other steps or at least a part of steps or stages of other steps.

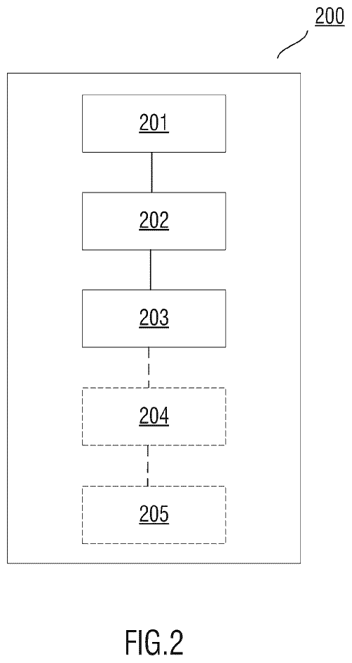

FIG. 2 provides an apparatus 200 incorporating teachings of the present disclosure for acquiring optimal control parameters of pumps. The apparatus 200 includes: an optimization model establishing module 201, used for establishing a black-box optimization model, with a constrained condition, regarding the flow and the head of a plurality of pumps; a simulation function calculating module 202, used for generating control parameters of the plurality of pumps through the optimization model, and calculating and obtaining the total flow, the total head and the total power of the plurality of pumps according to a simulation function of the pump and the control parameters; and a control parameter outputting module 203, used for, if the total flow and the total head satisfy the constrained condition, and the total power is minimum, outputting the control parameters.

In some embodiments, the control parameters include respective on-off, respective speeds, and respective flows of the plurality of pumps, and the simulation function calculating module (202) is further used for generating respective on-off, respective speeds and respective flows of the plurality of pumps through the optimization model.

In some embodiments, the apparatus includes that the numerical range of the respective speeds includes 80% to 120% of respective rated speeds; the numerical range of the respective flows includes zero to a maximum flow value; the respective on-off includes an on state and an off state, and the simulation function calculating module (202) is further used for generating, by the optimization model, the numerical range of the respective speeds of the plurality of pumps, being 80% to 120% of the respective rated speeds, the numerical range of the respective flows, being zero to a maximum flow value, and the states of the respective on-off, being an on state or an off state.

In some embodiments, the simulation function of the pump includes a head function and a power function of the pump regarding the flow at the rated speed, and the simulation function calculating module (202) is further used for calculating and obtaining the total flow, the total head and the total power of the plurality of pumps according to the head function and the power function of the pump regarding the flow at the rated speed and the control parameters.

In some embodiments, the apparatus further includes: an evolution strategy initializing module 204, used for initializing an evolution strategy of the optimization model; and an evolution strategy updating module 205, used for updating the evolution strategy of the optimization model.

In some embodiments, the apparatus may include more or fewer modules to implement the described functions. For example, at least one module in FIG. 2 may be further divided into a plurality of different sub-modules, each sub-module being used for performing at least part of the operations described herein in conjunction with the corresponding module. In addition, in some examples, the apparatus 200 may also include additional modules for performing other operations already described in the description. Furthermore, it will be understood by those skilled in the art that the exemplary apparatus 200 may be implemented with software, hardware, firmware, or any combination thereof.

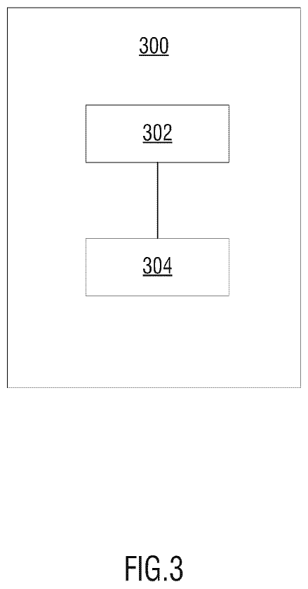

FIG. 3 depicts an example computer device incorporating teachings of the present disclosure. The computer device 300 includes a processor 302, the processor 302 executing a computer program stored in a memory 304. The computer program, when executed by the processor, implements one or more of the methods described herein.

A person skilled in the art may understand that the structure shown in FIG. 3 is only a block diagram of a partial structure related to a solution in the present application, which does not constitute a limitation to the computer device to which the present application is applied. In some embodiments, the computer device may include more components or fewer components than those shown in the block diagram, or some components may be combined, or a different component deployment may be used.

A person of ordinary skill in the art may understand that all or some of procedures of the method in the foregoing implementation modes may be implemented by a computer program instructing relevant hardware. The computer program may be stored in a non-volatile computer-readable storage medium. When the computer program is executed, the procedures of the foregoing method implementation modes may be included. References to the memory, the storage, the database, or other medium used in the implementation modes provided in the present application may all include at least one of a non-volatile memory and a volatile memory. The non-volatile memory can include a Read-Only Memory (ROM), magnetic tape, a floppy disk, a flash memory or an optical memory. The volatile memory may include a Random Access Memory (RAM) or an external cache memory. By way of illustration, rather than limitation, RAM may be in various forms, such as a Static Random Access Memory (SRAM) or a Dynamic Random Access Memory (DRAM), etc.

Some embodiments include a computer-readable storage medium, storing a computer program, the computer program, when executed by a processor, implementing one or more of the methods described herein.

Some embodiments include a computer program product, stored on a tangible computer-readable medium and including computer-executable instructions, the computer-executable instructions, when executed, enabling at least one processor to perform one or more of the methods described herein. Further, the computer program may be stored and run in the cloud for the execution of the method.

In some embodiments, the components of the program may be laid out on a plurality of devices, or on the cloud, for example the corresponding steps may be laid out, run locally or on local computer, or run on different cloud devices to transmit signals via communication connection, or may also be laid out, run locally or on a local computer. The present disclosure does not limit the described ways or methods, and the corresponding technologies can be flexibly laid out and deployed, and the methods can be performed and completed by making full use of devices and technologies such as the cloud, big data, and supercomputing power.

Some implementations of the present disclosure may include products. The products may include a storage medium used for storing logic. Examples of the storage medium may include one or more types of computer-readable storage media capable of storing electronic data, including a volatile memory or a non-volatile memory, a removable or non-removable memory, an erasable or non-erasable memory, a writable or rewritable memory, and the like. Examples of the logic may include various software units, such as software components, programs, applications, computer programs, applications, system programs, machine programs, operating system software, middleware, firmware, software modules, routines, subroutines, functions, methods, processes, software interfaces, application program interfaces (API), instruction sets, computational codes, computer codes, code segments, computer code segments, words, values, symbols, or any combination thereof. In some implementations, for example, the product may store executable computer program instructions, the executable computer program instruction, when executed by the processor, enabling a processor to perform the methods and/or operations described herein. The executable computer program instructions may include any suitable type of codes, for example, source codes, compiled codes, interpreted codes, executable codes, static codes, dynamic codes, and the like. The executable computer program instructions may be implemented according to a predefined computer language, manner or syntax for commanding a computer to perform a particular function. The instructions may be implemented by using any suitable high-level, low-level, object-oriented, visual, compiled and/or interpreted programming language.

What has been described above includes examples of the disclosed architecture. Of course, it is not possible to describe every conceivable combination of components and/or methods, but it will be understood by those skilled in the art that many other combinations and arrangements are also feasible. The novel architecture is therefore intended to cover all such substitutions, modifications and variations that fall within the spirit and scope of the appended claims.

What is claimed is:

1. A method for acquiring optimal control parameters of pumps, the method comprising:
establishing an optimization model with a constrained condition, regarding a flow and a head of a plurality of pumps;
generating control parameters of the plurality of pumps through the optimization model;
calculating a total flow, a total head, and a total power of the plurality of pumps according to a simulation function of the pump and the control parameters; and
if the total flow and the total head satisfy the constrained condition and the total power is minimum, transmitting the control parameters to a control for the pumps.

2. The method-according to claim 1, wherein:
the control parameters comprise respective on-off, respective speeds, and respective flows of the plurality of pumps; and
generating control parameters of the plurality of pumps through the optimization model comprises
generating respective on-off, respective speeds and respective flows of the plurality of pumps through the optimization model.

3. The method according to claim 2, wherein;
the numerical range of the respective speeds comprises 80% to 120% of respective rated speeds;
the numerical range of the respective flows comprises zero to a maximum flow value;
the states of the respective on-off comprise an on state and an off state; and
initializing the respective on-off, the respective speeds and the respective flows of the plurality of pumps through the optimization model comprises:
generating, by the optimization model, the numerical range of the respective speeds of the plurality of pumps, being 80% to 120% of the respective rated speeds, the numerical range of the respective flows, being zero to a maximum flow value, and the states of the respective on-off, being an on state or an off state.

4. The method according to claim 1, wherein:
the simulation function of the pump comprises a head function and a power function of the pump regarding the flow at the rated speed; and
calculating and obtaining the total flow, the total head and the total power of the plurality of pumps according to a simulation function of the pump and the control parameters comprises:
calculating and obtaining the total flow, the total head and the total power of the plurality of pumps according to the head function and the power function of the pump regarding the flow at the rated speed and the control parameters.

5. An apparatus for acquiring optimal control parameters of pumps, the apparatus comprising:
an optimization model establishing module to establish an optimization model, with a constrained condition, regarding flow and a head of a plurality of pumps;
a simulation function calculating module to generate control parameters of the plurality of pumps through the optimization model, and calculating and obtaining the total flow, the total head and the total power of the plurality of pumps according to a simulation function of the pump and the control parameters; and
a controller to, if the total flow and the total head satisfy the constrained condition, and the total power is minimum, operate the plurality of pumps using the control parameters.

6. The apparatus according to claim 5, wherein:
the control parameters comprise respective on-off, respective speeds, and respective flows of the plurality of pumps; and
the simulation function calculating module generates respective on-off, respective speeds and respective flows of the plurality of pumps through the optimization model.

7. The apparatus according to claim 6, wherein:
the numerical range of the respective speeds comprises 80% to 120% of respective rated speeds;
the numerical range of the respective flows comprises zero to a maximum flow value;
the states of the respective on-off comprise an on state and an off state; and
the simulation function calculating module generates, using the optimization model, the numerical range of the respective speeds of the plurality of pumps, at 80% to 120% of the respective rated speeds, the numerical range of the respective flows, being zero to a maximum flow value, and the states of the respective on-off, including an on state or an off state.

8. The apparatus according to claim 5, wherein:
the simulation function of the pump comprises a head function and a power function of the pump regarding the flow at the rated speed; and
the simulation function calculating module calculates the total flow, the total head, and the total power of the plurality of pumps according to the head function and the power function of the pump regarding the flow at the rated speed and the control parameters.

9-11. (canceled)
